(19) United States
(12) Patent Application Publication
(10) Pub. No.: US 2010/0113017 A1
(43) Pub. Date: May 6, 2010

(54) METHOD AND A SYSTEM FOR MANAGING SIGNALING PEAK LOADS

(75) Inventors: Peter Bleckert, Uppsala (SE); Anders Molander, Linkoping (SE); Paul Schliwa-Bertling, Ljungsbro (SE); Peter Östrup, Linkoping (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (PUBL)

(21) Appl. No.: 12/594,981

(22) PCT Filed: Apr. 10, 2007
(86) PCT No.: PCT/SE2007/050228

§ 371 Date: Oct. 7, 2009

(51) Int. Cl. H04W 64/00

(52) U.S. Cl. 455/433

(57) ABSTRACT

In densely populated areas a random period of time or an offset is added in order to avoid signaling congestion. Using the described method and system will reduce the signaling peak load on the signaling channels when many subscribers are changing Location Area at the same time. The method and system as described herein are easy to implement and does not require additional hardware resources or configurations on the network side.

### TECHNICAL FIELD

The present invention relates to a method and a device for managing signaling peak loads.

### BACKGROUND

Currently, in some scenarios such as when a fast moving train is moving from one Location Area (LA) to another Location Area there will be a very intense load increase on the signaling channels of the radio network due to the fact that many persons requiring a location area update are moved into the Location area simultaneously.

The problem of high signaling traffic load during peak hours at the border of location areas/registration areas has been known since long in GSM networks and has traditionally been solved by appropriate network dimensioning, i.e. by increasing the number of available signaling channels (SDCCHs) in border cells.

The result of a too high signaling traffic load at the border of a Location Area (LA) or Routing Area (RA) is that end users are unable to access communication services, such as voice or e-mail communications for certain time periods due to congestion caused by burst Location Area Update (LAU)/Routing Area Update (RAU) signaling. The problem arises because there will be a lot of colliding transmissions resulting in a great number of re-transmissions if many mobile stations try to signal simultaneously. The problem does not only affect subscribers moving at high speed, but also subscribers located at a LA border where such events occur. See also GP-070274 and GP-070204, which are available at: http://www.3gpp.org/ftp/tsg_geran/TSG_GERAN/GERAN_{—}33_Seoul/Docs/.

One proposed solution to this problem is the Overlapping Location Areas of the PDC system. However, such a solution will require a manual configuration of the radio network and also a re-configuration when the radio network changes its configuration. This will for example be the case when new base stations or radio network controllers RNCs are installed. Also, the impact on the existing standards is likely much larger if the radio network should signal several layers of cell identities to the mobile. As described in GP-070274, a solution avoiding such configuration is desired.

Hence, there is a need for a method and a system that is able to provide good access to communication services, such as voice or e-mail communications (e.g. voice or mail) to users close to the border of an LA/RA in densely-populated area. It is also desired to minimize the impact on configuration of already installed equipment such as base stations as much as possible. Also a network configuration based solution involving for example re-coordination of network structure should be avoided.

### SUMMARY

It is an object of the present invention to overcome or at least reduce some of the problems associated with signaling congestion in densely populated areas.

It is another object of the present invention to provide a method, a system and a device that is capable of reducing the peak load signaling in densely populated areas where people carrying mobile stations quickly and simultaneously move between different Location Areas and Routing Areas and which at the same time is easy to implement and which does not require reoccurring re-configurations.

These objects and others are obtained by the method and system as set out in the appended claims. Thus, by adding a random period of time in a procedure relating to the change of location area signaling congestion will be avoided. In accordance with one embodiment, a mobile station/User Equipment (UE) changing Location Area will wait for a random period of time, within a certain timeframe, before initiating the Location Update procedure in the new cell.

In accordance with another embodiment, a random offset is added to the locating procedure in the mobile is added in order to move the LA border.

In order to avoid the extra time being added on changes in Location Area boarders where signaling congestion is not a problem, a number of approaches can be taken. For example, an indication can be added to System Information ordering the UE to add the random waiting time (or random offset) or not. As another alternative, velocity information can be used to determine if the random waiting time (or random offset) should be added or not.

Using the method and system as described herein will decrease the load on the signaling channels when many subscribers are changing Location Area at the same time without extra configuration on the network side.

### BRIEF DESCRIPTION OF THE DRAWINGS

The present invention will now be described in more detail by way of non-limiting examples and with reference to the accompanying drawings, in which:

FIG. 1 is a view illustrating a scenario likely to cause signaling congestion.

FIG. 2 is a flowchart illustrating steps performed when distributing location update signaling in time in accordance with a first embodiment.

FIG. 3 is a flowchart illustrating steps performed when distributing location update signaling in space in accordance with a second embodiment.

### DETAILED DESCRIPTION

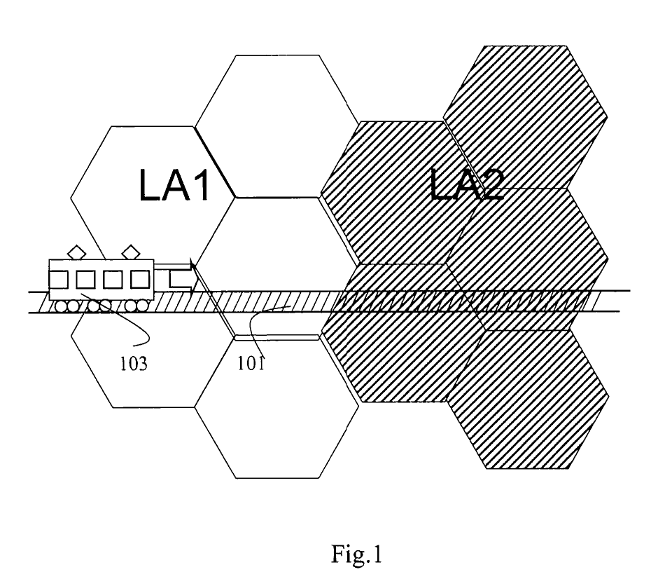

In FIG. 1, a view illustrating a scenario likely to cause signaling congestion is shown. Thus in FIG. 1 a number of cells in a cellular radio system are shown. A first group of the cells, the all white cells, belong to a first location area LA1 whereas a second group of cells, the striped cells, belong to a second location area LA2. Furthermore, in the area covered by the cells in FIG. 1 a railroad 101 is located. The railroad 101 runs through the location area LA1 and crosses the border to the location area LA2. When a train with many people onboard, many of which carrying a mobile station being switched on in the cellular radio system crosses the border between the two location areas there will be a very heavy signaling peak in the cellular radio system. Such a signaling peak is likely to cause congestion in the cellular radio station, which turn prevents all users in the area from establishing a connection to the cellular system, including users outside the moving train.

The problem arising will become worse if the train travels at high speed and through a densely populated area where many users both outside the train and onboard the train are connecting to the radio system at the location where the border between the location area LA1 and location area LA2 is situated.

In order to reduce the impact from the signalling peak load resulting from a train full of users entering a new location area the system as described herein is designed to delay the location area update for each user by some time period, thereby spreading the location area update signalling in time so that the impact of the signalling peak load become less burdensome on the system. It is desired to spread the location area update signalling evenly over a time interval acceptable for a user so that the signalling traffic load is spread in time as much as possible without deteriorating performance of the system beyond what is acceptable from a performance point of view. This can be obtained in a number of different ways.

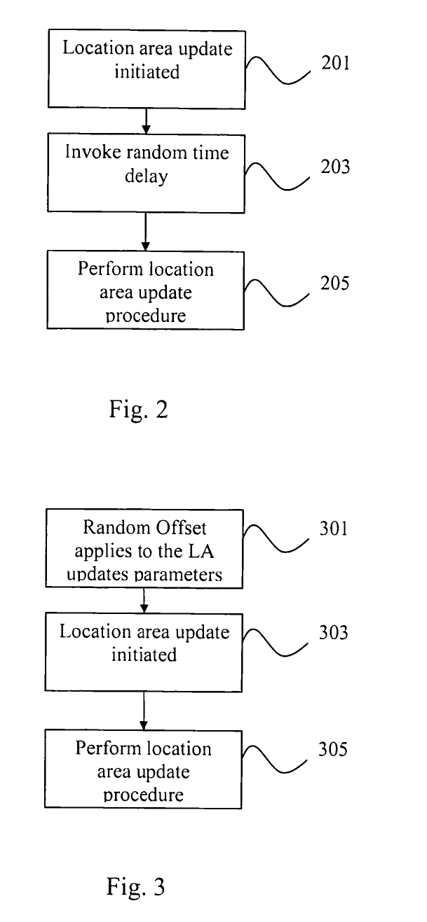

In accordance with one embodiment of the present invention the system is provided with a random waiting time. In accordance with such an embodiment, when a mobile station/user equipment (UE) is changing Location Area (LA), it is required to wait a certain time before performing the Location Update procedure. The time is preferably randomly selected at the time of change of Location Area within a specified time window. For example, a random time within a time window of four seconds may be employed. The time window can be of fixed nature, i.e. specified in the standard or it can be of configurable nature, i.e. being transferred to the UE in e.g. System Information. In FIG. 2 the steps performed in a cellular radio system when performing the location area update in accordance herewith is shown.

Thus, in FIG. 2, first in a step 201 a location area update is initiated. Next, in a step 203, the mobile station will calculate the random time delay and wait for that time period. When the time period has ended the mobile station/user equipment performs the location area update procedure, step 205. The signaling peak will now be reduced since the terminals in the train will wait different time periods before initiating the location update procedure.

In accordance with another embodiment, a random offset in the location procedure can be introduced to geographically move the location area border resulting in the same effect as the introducing a random waiting time as described above in conjunction with FIG. 2. In FIG. 3, a flowchart illustrating such a procedure is shown.

Thus. in FIG. 3, first in a step 301 the mobile station calculates the condition when a location area update should be initiated using an added a random offset to the location area update parameters. Next in a step 303, the mobile station will monitor radio condition until the calculated location area update condition is fulfilled. When this condition is fulfilled the user equipment performs the location area update procedure, step 305. The signaling peak will now be reduced since the mobile stations initiate the location update procedure under different radio conditions and, in the example with a moving train, not simultaneously.

Adding a random waiting time in all circumstances in all cells having Location Area boarders will incur an unnecessary waiting penalty in certain Location Area boarders under non-peak signaling load conditions. Thus, a triggering mechanism for ordering a User Equipment (UE) when to apply the Random Waiting Time or a random offset may therefore be useful.

Such a triggering mechanism can be introduced either through a System Information broadcast or by use of velocity information relating to a particular UE or as a combination of a broad cast and velocity information.

Using the method and system as described herein will reduce the signaling peak load on the signaling channels when many subscribers are changing Location Area or Routing Area at the same time. The method and system as described herein are easy to implement and does not require additional hardware resources or configurations on the network side.

1. A method of performing location area update for a mobile station connected to a cellular radio system, characterized by the step of:
adding a random period of time when performing a location area update procedure.

2. The method according to claim 1 characterized in that the step of adding a random period of time comprise the steps of:
initiating a location area update when a condition is met,
generating a random delay time, and
performing location area update signaling when the delay time has elapsed.

3. The method according to claim 2, characterized in that the random delay time is generated by the mobile station.

4. The method according to claim 1, characterized in that the step of adding a random period of time comprise the step of:
including a random offset to a condition for initiating a location area update.

5. The method according to claim 1, characterized in that the random period of time only is added when a triggering condition is fulfilled.

6. The method according to claim 5, characterized in that the triggering condition includes current signaling load and/or the velocity of a mobile station.

7. The method according to claim 1, wherein the location area update is a routing area update.

8. A cellular radio system adapted to perform a location area update for a mobile station connected to the cellular radio system, characterized by means for adding a random period of time when performing a location area update procedure.

9. The system according to claim 8, characterized by
means for initiating a location area update when a condition is met,
means for generating a random delay time, and
means for performing location area update signaling when the delay time has elapsed.

10. The system according to claim 9, characterized by
means for providing the condition for initiating a location area update with a random offset.

11. The system according to claim 8, characterized by means for only adding the random period of time when a triggering condition is fulfilled.

12. The system according to claim 11, characterized in that the triggering condition includes current signaling load and/or the velocity of a mobile station.

13. The system according to claim 8, wherein the location area update is a routing area update.

14. A mobile station adapted to perform location area update in a cellular radio system, characterized by means for adding a random period of time when performing a location area update procedure.

15. The mobile station according to claim 14, characterized by
means for initiating a location area update when a condition is met,
means for generating a random delay time, and
means for performing location area update signaling when the delay time has elapsed.

16. The mobile station according to claim 14, characterized by
means for providing the condition for initiating a location area update with a random offset.

17. The mobile station according to claim 14, characterized by means for only adding the random period of time only when a triggering condition is fulfilled.

18. The mobile station according to claim 17, characterized in that the triggering condition includes current signaling load and/or the velocity of a mobile station.

19. The mobile station according to claim 14, wherein the location area update is a routing area update.
